(19) United States
(12) Patent Application Publication
(10) Pub. No.: US 2014/0272000 A1
(43) Pub. Date: Sep. 18, 2014

(54) Liquids and Foodstuffs Containing beta-hydroxy-beta-methylbutyrate (HMB) in the Free Acid Form and Methods of Manufacturing or Producing the Same

(71) Applicant: Metabolic Technologies, Inc., Ames, IA (US)

(72) Inventors: Shawn Baier, Polk City, IA (US); John Rathmacher, Story City, IA (US); Joceylyn Seda, Ankeny, IA (US)

(73) Assignee: Metabolic Technologies, Inc., Ames, IA (US)

(21) Appl. No.: 14/209,614

(22) Filed: Mar. 13, 2014

Related U.S. Application Data
(60) Provisional application No. 61/782,567, filed on Mar. 14, 2013.

(51) Int. Cl. A23L 1/305; A23L 2/52; A23L 1/304; A23L 1/302

(52) U.S. Cl. CPC A23L 1/3051; A23L 1/302; A23L 2/52; A23L 1/304; A23L 1/305
USPC 426/72; 426/648; 426/590

(57) ABSTRACT

Liquids, substantially clear liquids and foodstuffs are described that contain free acid HMB. The liquids, substantially clear liquids and foodstuffs are substantially free of crude fat and may contain soluble proteins, carbohydrates, vitamins, minerals, amino acids, flavorings and other components. The products are shelf-stable and are substantially free of separation, gelation, sedimentation and coagulation.

This application claims priority to U.S. Patent Application Ser. No. 61/782,567 filed Mar. 14, 2013, which is herein incorporated by reference in its entirety.

### FIELD OF THE INVENTION

The invention relates generally to nutritional supplements containing β-Hydroxy-β-methylbutyrate (HMB) and more specifically to nutritional supplements containing HMB in the free acid form.

### BACKGROUND OF THE INVENTION

HMB has been found to be useful within the context of a variety of applications. Specifically, in U.S. Pat. No. 5,360,613 (Nissen), HMB is described as useful for reducing blood levels of total cholesterol and low-density lipoprotein cholesterol. In U.S. Pat. No. 5,348,979 (Nissen et al.), HMB is described as useful for promoting nitrogen retention in humans. U.S. Pat. No. 5,028,440 (Nissen) discusses the usefulness of HMB to increase lean tissue development in animals. Also, in U.S. Pat. No. 4,992,470 (Nissen), HMB is described as effective in enhancing the immune response of mammals. U.S. Pat. No. 6,031,000 (Nissen et al.) describes use of HMB and at least one amino acid to treat disease-associated wasting. In U.S. Pat. No. 6,103,764, HMB is described as increasing the aerobic capacity of muscle of an animal without a substantial increase in the mass of the muscle. In addition, HMB has been described as useful for improving a human's perception of his emotional state in U.S. Pat. No. 6,291,525.

HMB has been shown to have positive effects on maintaining and increasing lean muscle mass in cancer cachexia and AIDS wasting. In addition, a positive effect on muscle damage and the resulting inflammatory response caused by exercising which leads to muscle soreness, strength loss, and an increase in pro-inflammatory cytokines is seen with use of HMB.

It has previously been observed that HMB alone or in combination with other amino acids is an effective supplement for restoring muscle strength and function in young athletes. Further, it has been observed that HMB in combination with two amino acids, arginine and lysine, is effective in increasing muscle mass in elderly persons.

It is common to supplement traditional nutritional sources with nutritional supplements. Nutritional supplements come in many forms; for the present invention, the focus is on nutritional supplements in a non-emulsified substantially clear liquid form. These substantially clear liquid supplements often include vitamins, carbohydrates, soluble protein, amino acids, minerals and other nutrients. It is desirable to include HMB in these liquid supplements because of the known benefits of consuming HMB.

It may also be desirable to include HMB in other liquids, such as water, sports drinks, fruit juices, soft drinks, and other carbonated and noncarbonated beverages.

Simply adding CaHMB to these liquids, especially substantially clear liquid products containing additional calcium, results in an instable product. It is has been observed that adding CaHMB to these liquids results, over time, in clumping, coagulation, separation and sedimentation. This clumping, coagulation, separation and sedimentation likely occurs as at least some of CaHMB dissociates over time and the dissociated calcium and dissociated HMB interact with the soluble protein and/or other components (including vitamins, salts, and minerals) in the liquid resulting in the observed clumping, coagulation, separation and sedimentation. Thus, clear liquid supplements containing CaHMB have not been shelf stable, especially when the product has to be subjected to high heat during standard sterilization processes.

It has been observed that CaHMB does not react well with commercially available soluble-protein containing ready-to-drink products, as addition of CaHMB caused changes in the physical appearance, including sedimentation and clumping.

In some instances, however, clear liquid nutritional supplement products having shelf stability with CaHMB have been described. For example, U.S. Patent Application Publication No. 2011/0305799 describes a clear liquid beverage containing CaHMB. This clear liquid nutritional product has a pH in the range of 2.8 to 4.6, and it is stated in the application that within these pH ranges, the CaHMB remains associated and thus the interaction between the calcium and the protein in the formulation is minimized or avoided, resulting in minimizing or avoiding gelation, sedimentation and coagulation and providing a shelf-stable product.

CaHMB has historically been the preferred delivery form of HMB. Previously, numerous obstacles existed to both extensive testing and commercial utilization of the free acid form of HMB, and since it was thought there was no difference between the two forms from a pharmacokinetic perspective, the calcium salt was adopted as a commercial source of HMB. Until recently packaging and, in particular, distribution of dietary supplements has been better suited to handle nutrients in a powdered form and therefore the calcium salt of HMB was widely accepted. HMB-acid is a liquid and much more difficult to deliver or incorporate into products.

Currently, the manufacturing process for HMB has allowed for HMB free acid to be produced in a purity that allows for oral ingestion of the HMB free acid. Besides having a commercial source that is pure enough for oral ingestion, the HMB-acid needs to be buffered for oral ingestion, a process which only recently was determined due to the factors listed above which precluded previous use of HMB-acid.

It was assumed that ingestion of CaHMB would result in a rather quick dissociation of HMB from the calcium salt form. However, a recent study and corresponding patent application (U.S. App. Publication No. 20120053240) has shown that HMB in the free acid form has rather unique pharmacokinetic effects when compared to CaHMB ingestion. Use of HMB free acid (also called HMB-acid) improves HMB availability to tissues and thus provides a more rapid and efficient method to get HMB to the tissues than administration of CaHMB. It was shown that in many instances HMB free acid is a better delivery form of HMB.

Thus, it is desirable to use the free acid form of HMB in place of CaHMB in order to take advantage of free acid HMB's unique pharmacokinetic effects. It was expected, however, that addition of HMB-acid to a non-emulsified liquid nutritional supplement would have similar results to the results observed when CaHMB is added to a liquid. Specifically, it was expected that addition of HMB-acid would result in a layer of HMB-acid appearing at the top of the liquid, that the HMB acid would be observed floating through the liquid and/or that the HMB-acid would interact with the other ingredients in the liquid causing clumping, sedimentation and changes to the physical appearance of the beverage. It was thus surprising and unexpected that the addition of HMB-acid to a liquid nutritional supplement resulted in the HMB-acid disappearing almost immediately and remaining in solution indefinitely.

Thus, a need exists for beverages and non-emulsified substantially clear liquid nutritional supplements containing HMB in the free acid form.

### SUMMARY OF THE INVENTION

In one embodiment, the present invention is a liquid nutritional supplement containing HMB in the free acid form.

In another embodiment, the present invention is a clear liquid beverage containing HMB in the free acid form.

The nutritional supplement or beverage may contain calcium and soluble protein.

In yet another embodiment, the present invention is a method of adding free acid HMB to a liquid nutritional supplement or beverage. The addition of free acid HMB may occur during the process of manufacturing a liquid or beverage product or it may be done immediately prior to consuming the liquid or beverage.

Surprisingly, even though it was thought that free acid HMB and calcium (if present) in a clear liquid nutritional supplement containing soluble protein was not shelf stable and would result in the HMB and/or calcium (if present) interacting with the soluble protein to cause sedimentation and separation, the present invention comprises such a nutritional supplement containing soluble protein and free acid HMB and is still shelf stable. In addition, the addition of free acid HMB to a liquid that does not contain soluble protein also surprisingly does not result in a liquid sedimentation and separation that would be expected upon the addition of free acid HMB.

### BRIEF DESCRIPTION OF THE FIGURES

FIG. 1 shows photographs of the bottles showing the physical appearance of the liquid supplements studied in Example 1 at days 1, 4, 14 and 21.

FIG. 2a shows photographs of the bottles of ISOPURE showing the physical appearance of the ISOPURE samples studied in Example 3 at days 0, 7, 14, 28 and 42.

FIG. 2b shows photographs of the bottles of GNC-Protein Juice showing the physical appearance of the GNC-Protein Juice samples studied in Example 3 at days 0, 7, 14, 28 and 42.

FIG. 2c shows photographs of the bottles of Gatorade Recovery showing the physical appearance of the Gatorade Recovery samples studied in Example 3 at days 0, 7, 14, 28 and 42.

FIG. 2d shows photographs of the bottles of Spartos Protein water showing the physical appearance of the Spartos Protein water samples studied in Example 3 at days 0, 7, 14, 28 and 42.

FIG. 3 is a graph depicting the stability results of 300 mg of HMB-acid over 120 days.

FIG. 4 is a graph depicting the stability results of 1000 mg of HMB-acid over 120 days.

FIG. 5 is a graph depicting the stability results of 3000 mg of HMB-acid over 120 days.

### DETAILED DESCRIPTION OF PREFERRED EMBODIMENTS

In the preferred embodiment, the invention is a non-emulsified, substantially clear liquid nutritional supplement, most typically a beverage or drink, containing free acid HMB. The liquids of the present invention may contain water and free acid HMB. Additional ingredients may include soluble protein, amino acids, carbohydrates, vitamins and minerals such as calcium.

The invention comprises, at its base, HMB-acid and a liquid. In most instances, the liquid has a crude fat content of less than 1%. One of skill in the art will understand that the invention may include free fatty acids, such as DHA or EPA, yet still be considered to have less than 1% crude fat content. Water, sports drinks, juices, soft drinks, pharmaceutical liquids and substantially clear nutritional supplements such as Ensure Clear, IsoPure protein drink, GNC protein juice, Gatorade Recover, and Spartos protein water may comprise the liquid of the present invention, although the invention is not limited to these liquids.

While the preferred embodiment is HMB-acid in a liquid nutritional supplement, in another embodiment, HMB-acid may be added to food, such as honey, applesauce, fruit ribbons and other foodstuffs in the manufacturing process or after manufacturing prior to ingestion by the consumer.

In the present invention, HMB-acid is present in an effective amount. An effective amount includes a range from about 0.01 grams to about 0.2 grams of HMB-acid per kilogram body weight in twenty-four (24) hours. HMB-acid may also be administered to a human in an effective amount from about 0.5 grams to about 30 grams of HMB-acid per day. Thus, premade products that include HMB-acid will have HMB-acid present substantially in these ranges. Individual servings of HMB-acid to be added to a liquid or foodstuff will also have HMB-acid present substantially within these ranges.

Any soluble protein source is suitable for use in the present invention, including but not limited to whey protein concentrate, whey protein isolate, casein hydrolysate, hydrolyzed collagen and combinations thereof.

The liquid nutritional supplement may also include calcium, most preferably in a soluble form to minimize interaction with other components of the supplement (such as the free acid HMB or soluble protein if present). Nonlimiting examples of appropriate forms of calcium include calcium carbonate, calcium citrate, calcium gluconate, calcium lactate, calcium phosphate and calcium pantothenate.

The liquid nutritional supplement of the present invention may also include vitamins, such as vitamin D. As described in U.S. Patent Application Publication No. 2010/0179112, the combination of vitamin D and HMB has a synergistic effect, thus it may be desired to include vitamin D in the liquids of the present invention. Vitamin D may be included in any form, and most preferably as Vitamin D₃, also known as cholecalciferol. The amount of vitamin D to be included can be any amount of vitamin D, up to an amount causing toxicity. Typical amounts of vitamin D are up to 40001U, though much higher amounts may be included as described in U.S. Patent Application Publication No. 2010/0179112.

HMB-acid as used in this invention is generally in a liquid form. Other forms of HMB-acid within the scope of this invention include HMB-acid in a gel or gel-matrix form. Any and all forms of HMB-acid may be used in the present invention.

In the present invention, free acid HMB may be added to a liquid at any point prior to consumption. For example, free acid HMB may be added to a liquid or foodstuff during the manufacturing process and at any time during the manufacturing process. Suitable methods of manufacturing include but are not limited to a hot fill process, retort or aseptic filling of liquid products and the HMB-acid may be added at any time during any of these manufacturing processes.

There is no need to subject the liquid or foodstuff to any non-standard manufacturing steps, such as additional heating or cooling steps, or additional mixing or creation of a slurry. The HMB-acid can be added at any time during any manufacturing process and the product will be shelf-stable with minimal separation or sedimentation of the HMB-acid interacting with other components of the liquid or foodstuff.

HMB-acid may be added to a liquid or foodstuff after manufacture and prior to consumption. For example, HMB-acid may be provided separate from the liquid or foodstuff for a consumer to add to a liquid or foodstuff of their choice. Discretely measured packages of HMB-acid, most typically in a concentrate form, and most typically a gel form, may be provided to add to a defined amount of water, sports beverage, juice, substantially clear nutritional liquid, etc. The HMB-acid may be provided in single or multiple dose packages. The HMB-acid will mix in any potable liquid or foodstuff and is soluble in the aforementioned liquids and foodstuffs.

The present invention is not dependent on the pH of the liquid base to which HMB-acid is added. The pH of the liquid base may be as low as about 2.0.

The observation in the present invention that the addition of HMB-acid to liquids and foodstuffs would result in liquids and foodstuffs with very little sedimentation, gelation or coagulation of the HMB-acid interacting with other components of the liquid or foodstuff is surprising and unexpected. It is known in the art that the addition of calcium HMB to liquids such as water or liquids containing soluble protein results in the partial dissociation of calcium and HMB into the ion forms, resulting in sedimentation, gelation and coagulation. While U.S. Patent Application Serial No. 2011/0305799 describes the addition of calcium HMB to substantially clear nutritional liquids, it is made clear the fact that the calcium HMB remains associated, thus avoiding the interaction between the calcium and protein which minimizes these undesired effects. HMB-acid is by definition HMB in a dissociated form and it was expected that the free acid form would interact with soluble proteins and other components of the liquid which would result in sedimentation, etc. Surprisingly, the free acid form of HMB does not interact with any of the other components, thus providing a stable product with little to no separation or sedimentation. The observation that HMB-acid goes into solution almost instantly when added to a liquid was also unexpected. It was expected that the addition of HMB-acid to a liquid would result in the HMB-acid forming a layer at the top of the liquid, or floating throughout the liquid or that the HMB-acid would interact with the other ingredients in the liquid causing clumping, sedimentation and changes to the physical appearance of the beverage. Instead, addition of HMB-acid followed by slight shaking results in the immediate disappearance of the HMB-acid and a crystal clear liquid.

Further, the addition of HMB-acid had little to no impact on the flavor, texture, mouthfeel and stability of the liquid drink matrix.

It is understood by one of skill in the art that consumption of HMB-acid marked to be added to a liquid without adding the HMB-acid (usually in the form of a gel), is included in the scope of this invention.

### EXPERIMENTAL EXAMPLES

### Example 1

### Stability of Product Composition with the Addition of HMB (Free Acid and Calcium Salt Forms)

### Protocol:

1. N=2 (Two flavors of a commercially available ready-to-drink soluble-protein product; Ensure Clear, pH approximately 2.74)
2. Label the glass bottles A1-A3 and B1-B3. The labels correspond to the following conditions:

TABLE 1

| Label | Condition |
|---|---|
| A1 | Peach flavor control |
| A2 | Peach flavor CaHMB |
| A3 | Peach flavor HMB FA |
| B1 | Blueberry pomegranate control |
| B2 | Blueberry pomegranate CaHMB |
| B3 | Blueberry pomegranate HMB FA |

3. To bottles A2 and B2 1 g of CaHMB MTI 1208-100-02 TSI 12070630 added.
4. To bottles A3 and B3 0.8 g of HMB Free Acid MTI 1103-100-09 Lot 11010084 added.
5. 40 ml of Peach flavored product added to the bottles labeled A1-A3.
6. 40 ml of Blueberry Pomegranate flavored product added to the bottles labeled B1-B3.
7. Bottles were sealed with rubber caps and crimped shut. Then, they were mixed well and placed on shelf.
8. Appearances were noted and photos were taken daily (bottles were not disturbed).

### Results:

Table 2 reports the physical appearance of the ready-to-drink soluble-protein product (n=2) following the addition of CaHMB or HMB free acid and mixing. HMB was not added to the control bottles. Day 1 was recorded after initial mixing.

TABLE 2

| | Control/No | | W/HMB |
|---|---|---|---|
| | HMB | w/ CaHMB | free acid |
| Day 1 | Semi-Clear | Cloudy | Semi-Clear |
| Day 7 | Semi-Clear | Defined Separation | Semi-Clear |
| Day 14 | Semi-Clear | Defined Separation w/Particulates | Semi-Clear |
| Day 21 | Semi-Clear | Defined Separation w/Particulates | Semi-Clear |

In addition to the physical appearance notes, photos were taken at the time points noted above. These photos appear in FIG. 1.

### Example 2

### Study: Taste of Product with the Addition of HMB (Free Acid and Ca Salt Forms)

### Protocol:

1. N=2 (Two flavors of a commercially available ready-to-drink soluble-protein product; Ensure Clear, pH approximately 2.74)
2. Label the glass bottles A1-A3 and B1-B3. The labels correspond to the following conditions:

TABLE 3

| Label | Condition |
|---|---|
| A1 | Peach flavor control |
| A2 | Peach flavor CaHMB |
| A3 | Peach flavor HMB FA |
| B1 | Blueberry pomegranate control |
| B2 | Blueberry pomegranate CaHMB |
| B3 | Blueberry pomegranate HMB FA |

3. To bottles A2 and B2 1 g of CaHMB MTI 1208-100-02 TSI 12070630 was added and mixed.
4. To bottles A3 and B3 1.0 g of HMB Free Acid Lot 11010086 was added and mixed.
5. Bottles were tasted by investigator.
6. Between each sample tasting, a water mouth-washout was performed and 1 minute wait.

### Results:

Table 4 reports the taste of the ready-to-drink soluble-protein product (n=2) following the addition of CaHMB or HMB free acid and mixing. HMB was not added to the control bottles.

TABLE 4

| | Control/No | w/ CaHMB | W/HMB free acid |
|---|---|---|---|
| | HMB (1) | (2) | (3) |
| A | Sweet/Sour - | Slight change in flavor; | No change in |
| | peach | metallic after-taste | flavor; |
| | | bad mouthfeel | Slight increase in |
| | | | sour after-taste |
| B | Sweet/Sour - | Slight change in flavor; | No change in |
| | blueberry/pom | metallic after-taste | flavor; |
| | | bad mouthfeel | Sour after-taste |

### Conclusion:

The soluble-protein ready-to-drink products containing HMB free acid were surprisingly stable compared to those containing CaHMB. Additionally, the addition of HMB free acid had no impact on the physical appearance, mouthfeel or texture of the product when compared to the control with only a slight change in after-taste (more sour which is likely due to the low pH of the HMB free acid).

### Example 3

### Lab Study #21 Long Term Stability

1. Rinse 12 glass bottles with ethanol and let air dry overnight.
2. Label the glass bottles A1-A3, B1-B3, C1-C3 and D1-D3. The labels correspond to the following conditions:

TABLE 5

| Label | Condition |
|---|---|
| A1 | 40 ml |
| A2 | 250 mg CaHMB in 40 ml |
| A3 | 200 mg HMB FA in 40 ml |
| B1 | 40 ml |
| B2 | 250 mg CaHMB in 40 ml |
| B3 | 200 mg HMB FA in 40 ml |
| C1 | 40 ml |
| C2 | 250 mg CaHMB in 40 ml |
| C3 | 200 mg HMB FA in 40 ml |
| D1 | 40 ml |
| D2 | 250 mg CaHMB in 40 ml |
| D3 | 200 mg HMB FA in 40 ml |

3. To bottles A2-D2 CaHMB MTI 1208-100-02 TSI 12070630 was used.
4. To bottles A3-D3 HMB Free Acid MTI 1103-100-09 Lot 11010084 was used.
5. Add 40 ml of ISOPURE protein drink to A1-A3, 40 ml of GNC protein juice to B1-B3, 40 ml Gatorade Recover to C1-C3, and 40 ml Spartos protein water to D1-D3.
6. Flush with nitrogen and seal the bottles with rubber caps and metal clamp caps.
7. Mix well.
8. Take photo of bottles A1-A3, B1-B3, C1-C3, and D1-D3 every Friday. The photos appear in FIG. 2a-2d.
   The following tables 6-9 provide the nutritional information for each of the liquids tested (ISOPURE, GNC Protein Juice, Gatorade G3-Recover, and Spartos protein water.)

TABLE 6
Nutrition Facts: Grape Frost ISOPURE-FIG. 2a
Serving Size: 1 Bottle (20 fl. oz/591 mL)

| | AMOUNT PER | |
|---|---|---|
| | SERVING | DAILY VALUE |
| Calories | 160 | |
| Calories from Fat | 0 | |
| Total Fat | 0 g | 0% |
| Sodium | 80 mg | 3% |
| Potassium | 45 mg | 1% |
| Total Carbohydrate | 0 g | 0% |
| Protein | 40 g | 80% |
| Vitamin A | | 0% |
| Vitamin C | | 0% |
| Calcium | | 6% |
| Iron | | 0% |

TABLE 7
GNC - Protein Juice - Mixed Berry-FIG. 2b
Serving size 14 fl. Oz/414 ml
Servings per container: 2

| | AMOUNT PER | |
|---|---|---|
| | SERVING | DAILY VALUE |
| Calories | 170 | |
| Calories from Fat | 5 | |
| Total Fat | 0 g | 0% |
| Sodium | 50 mg | 2% |
| Potassium | 0 mg | 0% |
| Total Carbohydrate | 26 g | 9% |
| Dietary Fiber | 1 g | |
| Sugars | 24 g | |
| Protein | 15 g | 30% |
| Vitamin A | | 10% |
| Vitamin E | | 10% |
| Niacin | | 10% |
| Vitamin B6 | | 10% |
| Vitamin B12 | | 10% |
| Pantothenic Acid | | 10% |

TABLE 8
Gatorade G3 - Recover - Mixed Berry-FIG. 2c
Serving size 8 fl. oz/240 ml
Servings per container: 2
pH 3.68

| | AMOUNT PER | |
|---|---|---|
| | SERVING | DAILY VALUE |
| Calories | 110 | |
| Calories from Fat | 0 | |
| Total Fat | 0 g | 0% |
| Sodium | 105 mg | 4% |
| Potassium | 40 mg | 1% |
| Total Carbohydrate | 20 g | 7% |
| Dietary Fiber | 0 g | |
| Sugars | 20 g | |
| Protein | 8 g | 16% |
| Vitamin A | | 0% |
| Vitamin C | | 0% |
| Calcium | | 4% |
| Iron | | 0% |

TABLE 9
Spartos protein water-FIG. 2d
Serving size 8 fl. oz/240 ml
Servings per container: 2
pH approximately 3.05

| | AMOUNT PER | |
|---|---|---|
| | SERVING | DAILY VALUE |
| Calories | 60 | |
| Calories from Fat | 0 | |
| Total Fat | 0 g | 0% |
| Sodium | 10 mg | <1% |
| Potassium | 20 mg | 1% |
| Total Carbohydrate | 9 g | 3% |
| Sugars | 9 g | |
| Protein | 5 g | 10% |
| Vitamin A | | 5% |
| Vitamin C | | 5% |
| Calcium | | 5% |
| Vitamin D | | 5% |
| Vitamin E | | 5% |
| Vitamin B6 | | 15% |
| Folic Acid | | 15% |
| Vitamin B12 | | 15% |
| Magnesium | | 5% |

As seen in FIGS. 2a-2d, the liquids to which calcium HMB was added are cloudy and contain precipitate by 42 days. The calcium HMB bottles are bottles A2, B2, C2 and D2. The bottles containing liquid and HMB-acid (A3, B3, C3 and D3) are clear and precipitate-free at 42 days and look the same as the control bottles (no HMB) (A1, B1, C1 and D1).

### Example 4

This experiment was designed to observe the stability of HMB-acid at various concentrations in soluble protein over 120 days.

To analyze the stability of HMB free acid in the soluble protein (ISOPURE protein drink, Natures Best®, Hauppauge, N.Y.), different concentrations of HMB free acid were added to the recommended serving size of ISOPURE protein drink. The three concentrations were 300 mg/240 ml, 1000 mg/240 ml, and 3000 mg/240 ml. HMB free acid was measured for each solution using HPLC at 5 different time points: 0, 30, 60, 90, and 120 d. HMB free acid used was MTI 1301-100-03 (Lot 120111036). ISOPURE protein drink used was Lot 1212111132310. ISOPURE protein drink has a pH of approximately 2.54. All glassware and supplies used were autoclaved in preparation of the three different concentrations of HMB free acid in ISOPURE protein drink for the 5 different time points. Materials to be autoclaved were as follows: glass bottles, rubber and metal seals, pipette tips, and graduated cylinder. Autoclave Method #1 for dry goods in Building 3 of ISU Research Park was used.

Table 10 shows bottle labeling:

TABLE 10

| | Concentration | |
|---|---|---|
| Label | (mg/240 ml) | Time point |
| A0 | 300 | 0 |
| A1 | 300 | 30 days |
| A2 | 300 | 60 days |
| A3 | 300 | 90 days |
| A4 | 300 | 120 days |
| B0 | 1000 | 0 |
| B1 | 1000 | 30 days |
| B2 | 1000 | 60 days |
| B3 | 1000 | 90 days |
| B4 | 1000 | 120 days |
| C0 | 3000 | 0 |
| C1 | 3000 | 30 days |
| C2 | 3000 | 60 days |
| C3 | 3000 | 90 days |
| C4 | 3000 | 120 days |

For bottles in group A, 60 mg of HMBFA into each of the five bottles was added, and then 48 ml of ISOPURE protein drink was added. The HMBFA concentration was 1.25 mg/ml.
For bottles in group B 200 mg of HMBFA into each of the five bottles was added, and then 48 ml of ISOPURE protein drink was added. The HMBFA concentration was 4.16 mg/ml.
For bottles in group C, 600 mg of HMBFA into each of the five bottles was, and then 48 ml of ISOPURE protein drink was added. The HMBFA concentration was 12.5 mg/ml.
ISOPURE protein drink has a protein concentration of 0.0677 g/ml; the amount of protein in each sample was 3.25 g.
Table 11 shows actual weight (mg) and concentrations (mg/48 ml) of samples.

TABLE 11

| | | Concentration |
|---|---|---|
| Label | Weight (mg) | mg/ml) |
| A0 | 72.6 | 1.51 |
| A1 | 61.6 | 1.28 |
| A2 | 67.8 | 1.41 |
| A3 | 73.5 | 1.53 |
| A4 | 65.3 | 1.36 |
| B0 | 212.5 | 4.43 |
| B1 | 213.6 | 4.45 |
| B2 | 200.3 | 4.17 |
| B3 | 206.1 | 4.29 |
| B4 | 201.7 | 4.2 |
| C0 | 614.4 | 12.8 |
| C1 | 612.8 | 12.77 |
| C2 | 610.6 | 12.72 |
| C3 | 613.1 | 12.77 |
| C4 | 613.9 | 12.79 |

Each sample bottle was flushed with nitrogen and then the top of the bottle was sealed with rubber caps, crimped shut and mix well.
One bottle of each concentration was tested for HMB using SOP 113-04 HMB (modified standard curve), at Time 0, 30, 60, 90, and 120 d.

Table 12 shows the HMB standard curve to use.

TABLE 12

| | | .02M |
|---|---|---|
| | HPLC HMB Std | Phosphate |
| HMB STD | 20 mg/mL | Buffer |
| 0 | 0 | .75 mL |
| 0.5 | 25 ul | .725 mL |
| 1.0 | 50 ul | .700 mL |
| 2.0 | 100 ul | .650 mL |
| 4.0 | 200 ul | .550 mL |
| 8.0 | 400 ul | .350 mL |

To prepare the samples for testing, 0.5 ml of the sample was transferred to a microcentrifuge tube in quadruplet. Then 0.25 ml of KIV internal standard added to standards and three of each sample set. Finally, 0.25 ml 0.2M phosphate buffer was added to the three samples with KIV internal standard and 0.5 ml 0.2M phosphate buffer to the samples not containing KIV.

The concentrations of each HMBFA sample were now: 0.625 mg/ml, 2.08 mg/ml, and 6.25 mg/ml respectively.

The samples were considered stable with a ±5% of expected change HMB concentration over the four months with an allowable ±3% analytical variation. A linear regression was conducted on the data as a secondary measure of stability.

### Results

The three prepared concentrations of HMB Free acid with ISOPURE sports drink were analyzed for HMB concentrations using HPLC at 0, 30, 60, 90 and 120 d. The ingredients in the ISOPURE sports drink interfered with our KIV internal standard peak so external standard based calculations were used to quantify HMB in each sample. The quantified amount of HMB was compared to the expected amount of HMB for each sample at each test time and expressed in percent of expected. The results are presented in FIGS. 3-5. In general, the three different concentrations of HMB-FA in the sports drink tended to numerically decrease over time but no significant linear decrease was detected, p>0.05. The changes were less than 8.0%. The 300, 1000, and 3000 mg/serving of HMB-FA sample varied from 98.6% to 91.84, 98.1% to 94.96, and 97.28% to 93.57%% of expected, respectively.

FIG. 3 shows samples containing 300 mg of HMB free acid/serving of soluble protein that were evaluated for stability for 120 days. The decrease in HMB free acid was less than 8% of the expected amount of HMB free acid and there was no significant linear decrease, p<0.05.

FIG. 4 shows samples containing 1000 mg of HMB free acid/serving of soluble protein that were evaluated for stability for 120 days. The decrease in HMB free acid was less than 8% of the expected amount of HMB free acid and there was no significant linear decrease, p<0.05.

FIG. 5 shows samples containing 3000 mg of HMB free acid/serving of soluble protein that were evaluated for stability for 120 days. The decrease in HMB free acid was less than 8% of the expected amount of HMB free acid and there was no significant linear decrease, p<0.05.

This experimental example demonstrates that the addition of HMB-acid to a drink containing soluble protein results in HMB-acid remaining stable at room temperature for 120 days.

1. A substantially clear, non-emulsified liquid composition comprising beta-hydroxy-beta-methylbutyric acid (HMB-acid) between about 0.5 grams of HMB-acid to about 30 grams of HMB-acid.

2. The composition of claim 1, wherein the composition further comprises soluble protein.

3. The composition of claim 1, wherein the composition further comprises calcium.

4. The composition of claim 1, wherein the composition further comprises vitamins and minerals.

5. The composition of claim 1, wherein the substantially clear, non-emulsified liquid is shelf stable.

6. The composition of claim 1, wherein the substantially clear, non-emulsified liquid is selected from the group consisting of nutritional liquids, sports drinks, fruit juice, and carbonated beverages.

7. The composition of claim 1, wherein the substantially clear, non-emulsified liquid has a pH of about 2.0 to about 4.7.

8. The composition of claim 1, wherein the substantially clear, non-emulsified liquid has a pH of about 2.0 to about 2.8.

9. The composition of claim 8, wherein the substantially clear, non-emulsified liquid has a pH of about 2.0 to about 2.75.

10. A process for preparing a substantially clear, non-emulsified liquid composition comprising HMB-acid, wherein the HMB-acid is added to the nutritional composition at any time during the manufacturing process.

11. A concentrate comprising HMB-acid between about 0.5 grams of HMB-acid to about 30 grams of HMB-acid.

12. The concentrate of claim 11, wherein the concentrate is added to a ready-to-drink (RTD) beverage or foodstuff.

13. The concentrate of claim 12, wherein the concentrate is added to a ready-to-drink (RTD) beverage or foodstuff by the consumer of the RTD beverage or foodstuff.

14. A process for preparing the nutritional composition of claim 1, wherein the HMB-acid is added to a ready-to-drink (RTD) beverage.

15. A process for preparing the nutritional composition of claim 1, wherein the HMB-acid is added to a the liquid at any point during the manufacturing process.

16. A method for making a liquid composition comprising adding HMB-acid to a substantially clear, non-emulsified liquid composition, wherein addition of HMB-acid to the liquid composition does not adversely affect at least one of characteristics of the liquid consisting of physical appearance, mouthfeel, or texture.
